(19) United States
(12) Patent Application Publication
(10) Pub. No.: US 2008/0044729 A1
(43) Pub. Date: Feb. 21, 2008

(54) Electrochemical Cell Having "In Situ Generated" Component

(76) Inventor: Alexander Gilmour, Henley-on-Thames (GB)

Correspondence Address: Iandiorio & Teska, 260 Bear Hill Road, Waltham, MA, 02451, US

(21) Appl. No.: 10/566,064

(22) PCT Filed: Aug. 6, 2004
(86) PCT No.: PCT/GB04/03425

§ 371 Date: Jan. 26, 2006

(30) Foreign Application Priority Data
Aug. 8, 2003 (GB) 0318644.2

(51) Int. Cl. H01M 4/48; H01M 4/50; H01M 4/52

(52) U.S. Cl. 429/223; 429/209; 429/224; 429/231.3; 429/231.5

(57) ABSTRACT

An electrochemical cell having a solid polymer separator/electrolyte whose ion conductivity is markedly increased by in situ generation of a fluid acidic anhydride. The electrochemical cell comprises a solid polymer electrolyte, an anode of an alkali or alkaline earth metal such as lithium and a cathode containing the lithium or other alkali or alkaline earth metal salt of the acid anhydride to be electrochemically generated in addition to the main active material. The salt has the formula MAxOy where M is an alkali or alkaline earth metal such as lithium and A is a non-metallic element such as sulphur, nitrogen, carbon or phosphoros 0.31<=x<=2.0 and 1.3<=y<=4. The electrochemical cell has a much improved rate capability and low temperature performance, but no liquid constituents are required for assembly of the cell.

### BACKGROUND TO THE INVENTION

This invention relates to the enhancement of the ionic conductivity of a solid electrolyte, especially for rechargeable batteries and super capacitors, obviating the need for organic solvents which are expensive and which are also flammable, and thus constitute a safety hazard in large batteries.

Solid electrolytes, particularly those based on organic polymer compositions which contain basic sites (ether, secondary or tertiary amine, imide etc.), are now gaining favour in lithium rechargeable battery technology as a viable alternative and replacement for liquid electrolytes having a high percentage of organic solvents. The ionic conductivity of these polymer electrolytes is however inferior to that of the liquid types and is not acceptable for high rate, low temperature applications. Many so called “solid electrolyte” cells have indeed a significant amount of polar organic solvents added in order to raise the conductivity to acceptable levels. Such electrolytes with added solvents typically form a viscous gel which is sticky, and this makes control of electrode assembly into cells a difficult assembly operation. This gelled electrolyte must also be added to both the anode and cathode compositions in order to achieve acceptable ionic conductivity. The control of composition and handling of these electrodes gives rise to problems in quality assurance with a resulting cost penalty.

The use of an acid anhydride as a major electrolyte constituent in non-aqueous batteries was first demonstrated by American Cyanamid in the 1960's with a succession of patents involving the use of sulphur dioxide having a dissolved lithium salt, playing the role of both electrolyte vehicle and cathode in conjunction with lithium or other alkali metal as anode. A considerable amount of research and development work was carried out over the ensuing 25 years, mainly in the USA, towards better utilisation of this liquid electrolyte and cathode chemistry for both primary and secondary batteries. Several companies were successful in the production of lithium sulphur dioxide primary cells but their use was mainly restricted to military applications. Although a viable rechargeable battery based on the same chemistry was never realized, a sulphur dioxide based liquid electrolyte used in conjunction with a lithium cobalt oxide cathode has been demonstrated for high rate applications, the ionic conductivity of the sulphur dioxide electrolyte used being an order of magnitude greater than in existing organic solvent based electrolytes. The volatility of the sulphur dioxide electrolyte has precluded its use in most consumer applications, this accounting for the virtual cessation of further research and development work on sulphur dioxide chemistry for battery applications.

In patents from Schwartz (CA 1114894A, CA 1089929A and CA 1112719A) the use of lithium dithionite is disclosed as a charge transfer agent in an organic electrolyte system, unlike the solid electrolyte system used in the present invention.

GTE Laboratories (U.S. Pat. No. 4,403,021) claim the use of an electrolyte solute consisting of the reaction products of lithium sulphite and a Lewis acid dissolved in a liquid electrolyte/cathode material. This differs from the present invention which does not use a liquid electrolyte/cathode in the cell assembly.

Previous work by Lexel Technology Ltd (WO 95/34920A) disclosed the use of lithium sulphite and dithionite in conjunction with transition metal oxides as cathode materials to be used with liquid organic solvent based electrolytes. In the present invention, lithium dithionite plays an entirely different role by acting not as a cathode material but as an “in situ” source of sulphur dioxide in the absence of organic solvents.

One of the first successful lithium battery systems to use polymers having basic functionality due to the presence of nitrogen was patented by Schneider and Moser (U.S. Pat. No. 3,674,562). In the implementation of this patent, poly(vinyl-pyridine) was used in conjunction with iodine for the cathode, and this charge transfer complex also functioned as a solid state separator. This system inherently has a low rate capability and is non-rechargeable.

Lexel Technology Ltd has disclosed the use of thermally restructured poly(acrylonitrile), in conjunction with lithium sulphite as a rechargeable electrode (GB Patent 2335073). The electrolyte specified in the invention of GB Patent 2335073 was a liquid based on organic solvents using a micro porous polymeric separator.

### DETAILED DESCRIPTION OF THE INVENTION

The present invention provides an electrochemical cell which comprises the following:—

(i) a positive electrode which, in addition to the cathodic active material, contains a compound MAxOy, where M is an alkali or alkaline earth metal such as lithium and A is a non-metallic element such as sulphur, nitrogen, carbon or phosphorus where 0.3<=x<=2.0 and 1.3<=y<=4.0, such that on charging, the acid anhydride AₓO_{y} is generated “in situ”, and

(ii) a solid composite polymer film acting as separator whose structural units contain basic functional groups containing nitrogen atoms in 5 or 6 member heterocyclic rings or in tertiary aliphatic configuration into which is incorporated an ionisable salt LiX, having a higher decomposition voltage than MAxOy, where X is an acid radical which may be, but not limited to, one or more of the following:—
AlCl₄, BF₄, PF₆, ClO₄, CF₃SO₃, N(CF₃SO₂)₂.

The electrochemical cell according to this invention shows a marked increase in rate capability, particularly for rechargeable non-aqueous batteries and super capacitors and by obviating the need for organic solvents, results in lower material costs and eliminates the safety hazard associated with large capacity cells.

The present invention brings together the ease of manufacturing and leak resistance advantages of solid electrolytes with the performance enhancement due to the presence of sulphur dioxide or related acidic anhydrides in the electrolyte. Sulphur dioxide is generated at the cathode on first charging the cell and at the same time, lithium metal is electroformed at the anode. The solid electrolyte chosen for the implementation of the present invention this invention has a structure with basic functional sites which associate with sulphur dioxide and sulphur trioxide to give a non-volatile network thus facilitating lithium ion conduction.

Embodiments of the invention will now be described solely by way of example and with reference to the accompanying drawings in which:

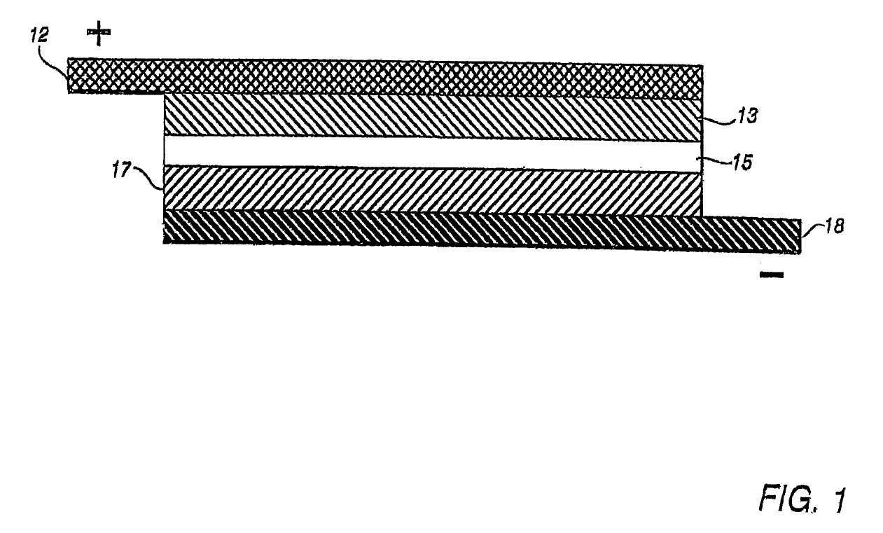

FIG. 1 is a section through an electrochemical cell of the present invention; and

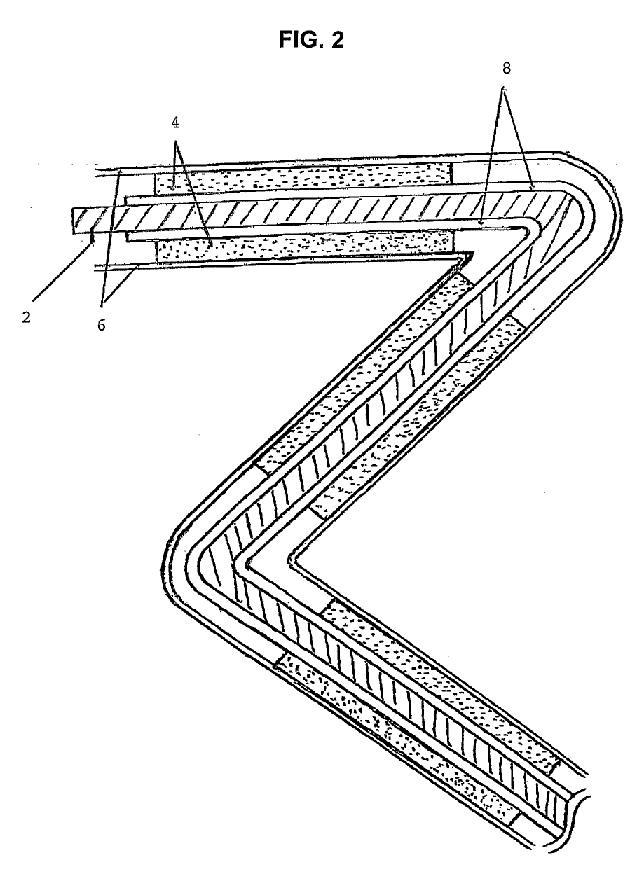

FIG. 2 shows an example of a multiple folded prismatic cell.

Referring to FIG. 1, the positive current collector 12, consists of aluminium or nickel foil, typically 15 microns thick, to which is bonded the active cathode 13. The most widely used material for the cathode is a lithiated intercalation compound such as LiCoO₂, carbon black or graphite and a polymeric binder such as poly(vinylidene difluoride) PVDF. The main feature of this invention is the addition of the lithium salt of a sulphur oxy-acid to the cathode formulation. The additive may be chosen from one of a number of lithium sulphur oxy-acid salts, particularly lithium dithionite Li₂S₂O₄, or lithium sulphite Li₂SO₃, added in a proportion of up to 10% by weight of cathode. The negative current collector 18, consists of nickel or copper foil, typically 12 microns thick, to which the anode material 17, consisting of meso carbon or graphite bound together with around 10% of a suitable polymer. The separator/electrolyte 15, interposed between the positive and negative electrodes, is typically around 75 microns thick and is prepared from a polymer having basic or tertiary nitrogen groups in its structure and an electrolyte salt both of which are dissolved in a common solvent. Suitable polymers include poly(vinyl pyridine), poly(vinylpyrrolidone) and thermally restructured poly(acrylonitrile). The electrolyte salt may be one or more chosen from LiAlCl₄, LiBF₄, LiPF₆, LiClO₄, LiN(CF₃SO₂)₂, Li(₉F₃SO₃). Other lithium salts which are preferably but not necessarily soluble in sulphur dioxide may be used as an implementation of this invention.

An electrochemical cell having the structure described above may take the form of a coin cell, a wound cylindrical cell or a multifolded prismatic format. The latter is preferred for large cells and supercapacitors. FIG. 2 shows an example of a multiple folded prismatic cell. The multiple folded prismatic cell comprises an anode 2, cathodes 4, cathode current collectors 6, and separators/electrolyte 8.

In order to facilitate a full and complete understanding of the present invention, reference will now be made to the following non-limiting Examples.

### EXAMPLE I

A cathode was prepared by mixing together lithium cobalt oxide 77%, Super P carbon 6%, lithium dithionite 10% and PVDF binder 7%, all by weight. The binder was first dissolved in N-methyl pyrrolidone as a 4.5 w/v solution. The slurry was coated by doctor blade technique on to aluminium foil 15 microns thick. After solvent removal in an anhydrous atmosphere, the cathode was dried under vacuum at 105° C. for 8 hours. The separator/electrolyte was prepared by making up a solution of PVDF, poly(4-vinylpyridine) and LiAlCl₄ (1:2:3 weight ratio) in a mixture of diamethylformamide and N-methyl pyrrolidone. This solution was coated by doctor blade technique on to the previously prepared graphite anode already coated on to nickel foil. The solvents were removed by heating to 105° C. in a dry inert atmosphere for 1 to 2 hours. The anode/separator/electrolyte and the cathode were then laminated together using steel rollers to make a cell as shown in FIG. 1.

### EXAMPLE II

In this Example, the same cathode and anode as that of Example I were used with a different separator/electrolyte composition. The lafter was prepared using anhydrous poly(vinylpyrrolidone) and LiN(CF₃SO₂)₂ dissolved in a mixture of dimethylformamide and propylene carbonate. The solution was coated on to the anode as described in Example I, dried under vacuum to remove the solvents and then laminated on to the cathode.

### EXAMPLE III

In this Example, the cathode was a composite of vanadium (IV) oxide V₂O₄ and lithium sulphite Li₂SO₃ in a 1:1 molar ratio. The cathode mix was prepared using 85% of this active material, 5% Super P carbon, 6% thermally restructured poly(acryonitrile) and 4% PVDF binder. The procedure for preparation and coating of the paste were the same as in Example I. The separator/electrolyte was prepared using poly(acryonitrile) thermally restructured at 250° C. under vacuum and LiAlCl₄. These materials were dissolved in a mixture of N-methyl pyrrolidone and dimethylformamide. The solution was coated on to the anode as described in Example I, dried under vacuum to remove the solvents and then laminated on to the cathode.

### EXAMPLE IV

In this Example, the cathode was prepared by mixing together lithium manganese (III, IV) oxide, LiMn₂O₄ (80%), lithium sulphite (9%), Super P carbon (6%) and PVDF binder (5%) as a 4.5 w/v solution in N-methyl pyrrolidone. The cathode mix was coated on to expanded nickel foil. The separator/electrolyte was prepared using poly(4-vinylpyridine) and LiAlCl₄ in dimethylformamide. This solution was coated on to the cathode which had previously had the carrier solvent removed under vacuum. Following a further drying operation, the composite cathode and separator/electrolyte was laminated to a lithium foil anode pressed on to a copper foil current collector.

The cells fabricated as described above were charged at a current density up to 0.2 ma/cm², and a maximum voltage of 4.2V in laboratory cells having a pressure monitor. After allowing to stand for at least 3 days. the cells were cycled at a current density of 0.5 ma/cm². Following repeated cycling at this higher rate, no excess pressure was generated in any of the cells tested. The conductivity of the original solid polymer electrolyte was observed to increase by a factor of between 10 and 30 fold on “in situ” generation of the sulphur oxides.

1. An electrochemical cell which comprises the following:
(i) a positive electrode which, in addition to the cathodic active material, contains a compound MAₓO_{y}, where M is an alkali or alkaline earth metal and A is a non-metallic element where 0.3<=x<=2.0 and 1.3<=y<=4.0, such that on charging, the acid anhydride AₓO_{y} is generated “in situ”, and
(ii) a solid composite polymer film acting as separator whose structural units contain basic finctional groups containing nitrogen atoms in 5 or 6 member heterocyclic rings or in tertiary aliphatic configuration into which is incorporated an ionisable salt LiX, having a higher decomposition voltage than MAₓO_{y}, where X is an acid radical.

2. An electrochemical cell as claimed in claim 1 wherein the alkali metal is lithium.

3. An electrochemical cell as claimed in claim 1 wherein the non-metallic element is sulphur, nitrogen, carbon or phosphorus.

4. An electrochemical cell as claimed in claim 1 wherein the acid radical X is one or more of the following:
AlC1₄, BF₄, PF₆, ClO₄, CF₃SO₃, N(CF₃SO₂)₂.

5. An electrochemical cell as claimed in claim 1 wherein the alkali metal M is lithium, and the element A is sulphur.

6. An electrochemical cell as claimed in claim 1 wherein the compound MAₓO_{y} is lithium dithionite.

7. An electrochemical cell as claimed in claim 1 wherein the compound MAₓO_{y} is lithium sulphite.

8. An electrochemical cell as claimed in claim 1 wherein the compound MAₓO_{y} is sodium dithionite.

9. An electrochemical cell as claimed in claim 1 wherein the solid polymer is poly(4-vinylpyridine), less than 5% cross linked.

10. An electrochemical cell as claimed in claim 1 wherein the solid polymer is poly(vinylpyrrolidone).

11. An electrochemical cell as claimed in claim 1 wherein the solid polymer is thermally restructured poly(acrylonitrile)-(CH═C—CN)—.

12. An electrochemical cell as claimed in claim 1 wherein the cathode active material is lithium cobalt oxide LiCoO₂ or a mixed nickel cobalt oxide LiNi_{0.85}Co_{0.15}O₂.

13. An electrochemical cell as claimed in claim 1 wherein the cathode active material is lithium sulphite and a transition metal oxide such as VO₂ or MₙOₓ where 2>=x>=1.

14. An electrochemical cell as claimed in claim 1 when used as a primary or rechargeable battery or a supercapacitor.
